(19) United States
(12) Patent Application Publication
(10) Pub. No.: US 2023/0304196 A1
(43) Pub. Date: Sep. 28, 2023

(54) SELF-LOCATING, DIELECTRIC, IMPACT RESISTANT TEXTILE SLEEVE AND METHOD OF CONSTRUCTION THEREOF

(71) Applicant: FEDERAL-MOGUL POWERTRAIN LLC, Northville, MI (US)

(72) Inventors: Alice Kaing, Margny-les-Compiegne (FR); Amelie Simoens, Compiegne (FR); Michael Horckmans, Etavigny (FR); Mickael Pujos, Saint Etienne (FR)

(21) Appl. No.: 18/126,154

(22) Filed: Mar. 24, 2023

Related U.S. Application Data
(60) Provisional application No. 63/323,975, filed on Mar. 25, 2022.

(51) Int. Cl. D03D 1/00; D03D 15/573; D03D 15/283; D03D 15/513; H02G 3/04

(52) U.S. Cl. CPC D03D 1/0043; D03D 15/573; D03D 15/283; D03D 15/513; D03D 1/0041; H02G 3/04; D10B 2331/04; D10B 2401/04; D10B 2401/063; D10B 2401/02; D10B 2401/16; D10B 2505/00

(57) ABSTRACT

A textile sleeve for routing and protecting an elongate member has a wall including a textile layer with an inner surface and an opposite outer surface extending lengthwise along a central longitudinal axis between opposite ends. The inner surface is configured to bound a cavity sized for receipt of the elongate member therein. The textile layer is formed of yarns interlaced with one another, wherein a least some of the yarns include multifilaments resistant to heat and/or monofilaments resistant to heat, rendering the sleeve heat-resistant. A silicone-based coating is adhered to the outer surface to provide enhanced heat-resistance, dielectric protection and impact resistance.

### CROSS-REFERENCE TO RELATED APPLICATION

This application claims the benefit of U.S. Provisional Application Ser. No. 63/323,975, filed Mar. 25, 2022, which is incorporated herein by reference in its entirety.

### BACKGROUND OF THE INVENTION

### 1. Technical Field

This invention relates generally to textile sleeves for protecting elongate members, and more particularly to flexible, dielectric, impact resistant textile sleeves.

### 2. Related Art

It is known to contain and protect elongate members, such as wires and wire harnesses, for example, in circumferentially continuous and wrappable textile sleeves to provide protection to cables, wires, and hoses contained therein. Improvements of known circumferentially continuous and wrappable textile sleeves are desired to provide enhanced protection, including dielectric resistance protection and impact resistance protection, while also being flexible for routing cables, wires or hoses through winding areas, while also having a low, non-bulky radially extending profile for applications having tight passages and weight restrictions, such as aircraft and aerospace applications, for example, while being economical in manufacture.

### SUMMARY OF THE INVENTION

One aspect of the invention provides a textile sleeve for routing and protecting an elongate member. The textile sleeve has a wall including a textile layer with an inner surface and an opposite outer surface extending lengthwise along a central longitudinal axis between opposite ends. The inner surface is configured to bound a cavity sized for receipt of the elongate member therein. The textile layer is formed of yarns interlaced with one another, wherein a least some of the yarns include multifilaments resistant to heat and/or monofilaments resistant to heat, thus, rendering the sleeve heat-resistant. A silicone-based coating is adhered to the outer surface to provide enhanced heat-resistance, dielectric protection and impact resistance.

In accordance with another aspect of the invention, at least some of the yarns are formed of polyester.

In accordance with another aspect of the invention, the polyester is provided as a high tenacity polyethylene terephthalate (PET).

In accordance with another aspect of the invention, at least some of the PET yarns are provided as monofilaments and/or multifilaments.

In accordance with another aspect of the invention, at least some of the yarns are provided being resistant to heat.

In accordance with another aspect of the invention, at least some of the yarns can be provided being cut resistant.

In accordance with another aspect of the invention, the yarns include warp yarns extending generally parallel to said central longitudinal axis and weft yarns extending generally transversely to said central longitudinal axis, said warp yarns being woven with said weft yarns.

In accordance with another aspect of the invention, the wall can be constructed to extend widthwise between opposite edges, with the opposite edges being configured to be wrapped about the central longitudinal axis to bound the elongate member within the cavity.

In accordance with another aspect of the invention, at least some of the weft yarns can be heat-set to bias the wall to take-on a tubular configuration with the opposite edges being biased in overlapping relation with one another.

In accordance with another aspect of the invention, the yarns can be braided with one another.

In accordance with another aspect of the invention, the wall can be constructed being circumferentially continuous.

In accordance with another aspect of the invention, a method of constructing a textile sleeve for routing and protecting an elongate member is provided. The method includes interlacing yarn to form a textile layer having an inner surface and an outer surface extending along a central longitudinal axis between opposite ends. The inner surface is configured to bound a cavity sized for receipt of the elongate member. The method further includes bonding a silicone-based coating on the outer surface.

In accordance with another aspect of the invention, the method can further include interlacing the yarns with one another in a weaving process.

In accordance with another aspect of the invention, the method can further include weaving the yarns including warp yarns extending generally parallel to the central longitudinal axis and weft yarns extending generally transversely to the warp yarns, and providing at least some of the warp yarns and/or weft yarns as monofilaments and/or multifilaments of cut-resistant material and/or high tenacity PET.

In accordance with another aspect of the invention, the method can further include weaving the wall being circumferentially continuous.

In accordance with another aspect of the invention, the method can further include weaving the wall having opposite edges configured to be wrapped about the central longitudinal axis to bound the elongate member within the cavity.

In accordance with another aspect of the invention, the method can further include heat-setting at least some of the weft yarns to bias the opposite edges in overlapping relation with one another.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1A is schematic perspective view of a wrappable sleeve constructed in accordance with one aspect of the invention, with the wrappable sleeve shown wrapped about an elongate member to be protected therein;

FIG. 1B is schematic perspective view of a circumferentially continuous sleeve constructed in accordance with another aspect of the invention, with the circumferentially continuous sleeve shown disposed about an elongate member to be protected therein;

FIG. 2A schematically illustrates a weaved section of a portion of an interlaced layer of the sleeves of FIGS. 1A and 1B; and

FIG. 2B schematically illustrates a braided section of a portion of an interlaced layer of the sleeves of FIGS. 1A and 1B.

### DETAILED DESCRIPTION OF PRESENTLY PREFERRED EMBODIMENTS

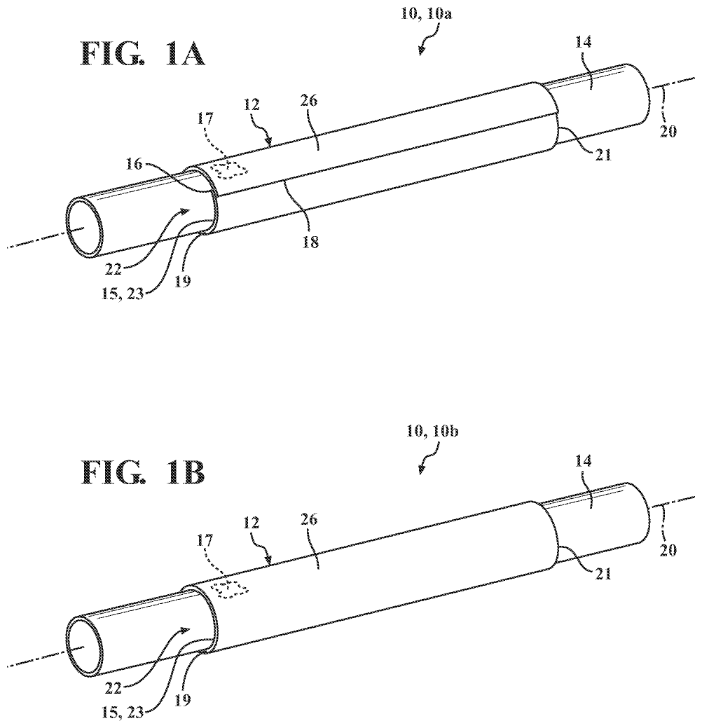

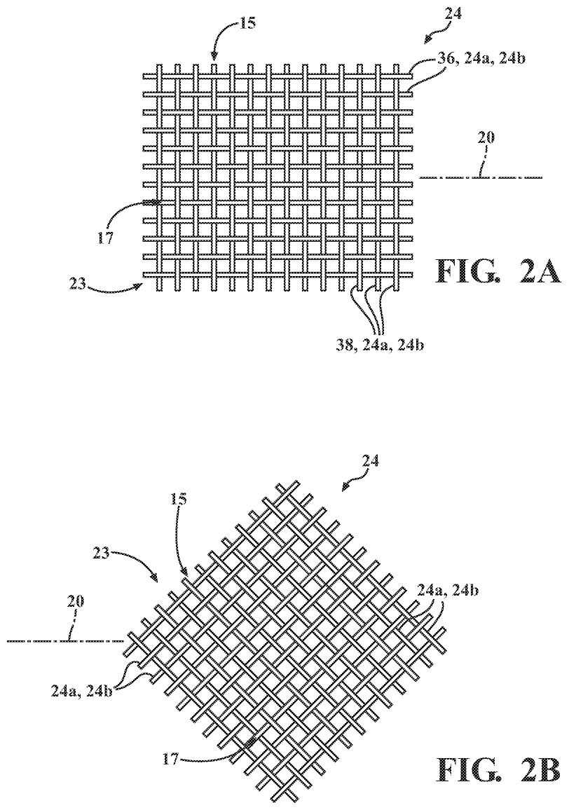

Referring in more detail to the drawings, FIGS. 1A and 1B show a schematic representation of a wrappable 10a and circumferentially continuous 10b textile sleeve, respectively, constructed in accordance with different aspects of the invention, wherein textile sleeves 10a, 10b are discussed hereafter generically as sleeve 10, with common reference numerals being used to identify like features of the sleeves 10a, 10b, unless otherwise specified. The sleeve 10 has a flexible, elongate wall 12 for routing and protecting one or more elongate member(s) 14, such as a cable, wires, and pipe, for example, to provide a variety of type of protection, including dielectric protection, protection against abrasion, protection against thermal conditions including high heat and fire, fluid absorption and ingress, e.g. water, oil, fuel, and the like, and other environmental conditions, such as contamination. The wall 12 can be constructed having any suitable size, including length and diameter. The wall 12 has an inner surface 15 and an opposite outer surface 17 extending lengthwise about a longitudinal central axis 20 between opposite ends 19, 21, with inner surface 15 bounding a cavity 22 sized for receipt of elongate member 14 therein. The wrappable sleeve 10a has opposite edges 16, 18 that extend parallel or generally parallel (intended to mean that to the naked eye, a person possessing ordinary skill in the art (POSA) would view the relationship to be parallel, though it may not be truly parallel) to the longitudinal central axis 20, wherein the opposite edges 16, 18 are wrappable into overlapping relation with one another in “cigarette wrapped” fashion to fully enclose the elongate member 14 within the central cavity 22. The wall 12 has an inner, interlaced textile layer 23 formed of yarns 24 interlaced with one another in one of a woven (a portion of the entire woven textile layer 23 is shown in FIG. 2A, with the remaining woven portion not shown being the same) or braided (a portion of the entire braided textile layer 23 is shown in FIG. 2B, with the remaining braided portion not shown being the same) fashion, wherein a least some of the yarns 24 include multifilaments 24a (a multifilament is a term well known to a POSA, known to be a single yarn including multiple filaments intertwined with one another) resistant to heat and/or monofilaments 24b (a monofilament is a term well known to a POSA, known to be a single, solid filament of material) resistant to heat. A silicone-based coating 26 is adhered to the outer surface 17 of the interlaced textile layer 23, shown as being adhered to the entirety of the outer surface 17, wherein the silicone-based coating 26 provides the dielectric protection, while enhancing the heat-resistance and abrasion protection to the elongate member 14, and protection against fluid absorption/ingress.

The silicone-based coating 26 is a continuous, fluid impervious coating, thereby being impervious to water, fuel (e.g. kerosene), oil, and the like, to render the wall 12 fluid impervious as well as fluid repellant. As such, fluid is prevented from being absorbed by the textile layer 23, thus, preventing water, fuel and the like from compromising the ability of the sleeve 10 to provide the desired levels of protection discussed above. The silicone-based coating 26 can include at least one or both of a flame retardant and a heat stabilizer, and can be provided having a thickness between about 0.1-3.0 mm, by way of example and without limitation, thereby contributing to the wall 12 having a radially narrow, low profile, thereby enhancing the flexibility and ability to be routed in relatively small, tight spaces.

The interlaced yarns 24 can be woven, including warp yarns 36 extending generally parallel to the central longitudinal axis 20 and weft yarns 38 extending generally transversely to the central longitudinal axis 20. The warp yarns 36 can be woven with the weft yarns 38 in any desired weave pattern, including a plain weave, twill weave, satin weave or basket weave, for example, with the plain weave pattern being preferred to provide a smooth, stable and uniform protection pattern, with the smoothness facilitating bonding of the silicone-base coating 26 to the outer surface 17. The warp yarns 36 can be provided entirely from the multifilaments 24a, with the multifilaments 24a being resistant to heat (high temperature resistant); entirely from the monofilaments 24b, with the monofilaments 24b being resistant to heat (high temperature resistant), or a mixture thereof. In similar fashion, the weft yarns 38 can be provided entirely from the multifilaments 24a, with the multifilaments 24a being resistant to heat; entirely from the monofilaments 24b, with the monofilaments 24b being resistant to heat, or a mixture thereof. The warp yarns 36 and/or the weft yarns 38 can be formed of polyester, and in particular of high tenacity polyethylene terephthalate (PET), wherein the warp yarns 36 and the weft yarns 38 can be provided as the same type of yarn in their entirety, or different, as desired for the intended application.

In accordance with another aspect of the disclosure, with reference to FIGS. 2A and 2B, the sleeve 10a, 10b, respectively, can be woven (FIG. 2A) or braided (FIG. 2B) with the aforementioned multifilaments 24a and/or monofilaments 24b.

In accordance with another aspect of the invention, a method of constructing a textile sleeve 10a, 10b is provided. The method includes interlacing yarn 24 to form a textile layer 23 having an inner surface 15 and an outer surface 17 extending along a central longitudinal axis 20 between opposite ends 19, 21. Further, configuring the inner surface 15 to bound a cavity 22 sized for receipt of the elongate member 14. Further yet, bonding a silicone-based coating 26 on the outer surface 17.

In accordance with another aspect of the invention, the method can further include interlacing the yarns 24 with one another in a weaving process.

In accordance with another aspect of the invention, the method can further include weaving the yarns 24 including warp yarns 36 extending generally parallel to the central longitudinal axis 20 and weft yarns 38 extending generally transversely to the warp yarns 36, and providing at least some of the warp yarns 36 and/or weft yarns 38 as monofilaments 24b and/or multifilaments 24a of cut-resistant material and/or high tenacity PET.

In accordance with another aspect of the invention, the method can further include weaving the wall 12 being circumferentially continuous (FIG. 2B).

In accordance with another aspect of the invention, the method can further include weaving the wall 12 having opposite edges 16, 18 (FIG. 2A) configured to be wrapped about the central longitudinal axis 20 to bound the elongate member 14 within the cavity 22.

In accordance with another aspect of the invention, the method can further include heat-setting at least some of the weft yarns 38 to bias the opposite edges 16, 18 in overlapping relation with one another.

In accordance with another aspect of the invention, the method can further include interlacing the yarns 24a, 24b with one another in a braiding process.

In accordance with another aspect of the invention, the method can further include braiding the wall 12 being circumferentially continuous.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A textile sleeve for routing and protecting an elongate member, comprising:
a wall including a textile layer having an inner surface and an opposite outer surface extending lengthwise along a central longitudinal axis between opposite ends, said inner surface being configured to bound a cavity sized for receipt of the elongate member, said textile layer being formed of yarns interlaced with one another, wherein a least some of said yarns include multifilaments resistant to heat and/or monofilaments resistant to heat; and
a silicone-based coating adhered to said outer surface.

2. The textile sleeve of claim 1, wherein at least some of said yarns are formed of polyester.

3. The textile sleeve of claim 2, wherein said polyester is high tenacity polyethylene terephthalate (PET).

4. The textile sleeve of claim 3, wherein at least some of said PET yarns are provided as monofilaments and/or multifilaments.

5. The textile sleeve of claim 4, wherein at least some of said yarns are provided being resistant to heat.

6. The textile sleeve of any one of claim 4, wherein at least some of said yarns are provided being cut resistant.

7. The textile sleeve of claim 6, wherein said yarns include warp yarns extending generally parallel to said central longitudinal axis and weft yarns extending generally transversely to said central longitudinal axis, said warp yarns being woven with said weft yarns.

8. The textile sleeve of claim 7, wherein said wall extends widthwise between opposite edges configured to be wrapped about the central longitudinal axis to bound the elongate member within the cavity.

9. The textile sleeve of claim 8, wherein at least some of said weft yarns are heat-set to bias said wall to take-on a tubular configuration with said opposite edges being biased in overlapping relation with one another.

10. The textile sleeve of claim 7, wherein said wall is circumferentially continuous.

11. The textile sleeve of claim 1, wherein said yarns are braided with one another.

12. The textile sleeve of claim 11, wherein said wall is circumferentially continuous.

13. A method of constructing a textile sleeve for routing and protecting an elongate member, comprising:
interlacing yarn to form a textile layer having an inner surface and an outer surface extending along a central longitudinal axis between opposite ends, said inner surface being configured to bound a cavity sized for receipt of the elongate member; and
bonding a silicone-based coating on the outer surface.

14. The method of claim 13, further including interlacing the yarns with one another in a weaving process.

15. The method of claim 14, further including weaving the yarns including warp yarns extending generally parallel to the central longitudinal axis and weft yarns extending generally transversely to the warp yarns, and providing at least some of the warp yarns and/or weft yarns as monofilaments and/or multifilaments of cut-resistant material and/or high tenacity PET.

16. The method of claim 15, further including weaving the wall being circumferentially continuous.

17. The method of claim 15, further including weaving the wall having opposite edges configured to be wrapped about the central longitudinal axis to bound the elongate member within the cavity.

18. The method of claim 17, further including heat-setting at least some of the weft yarns to bias the opposite edges in overlapping relation with one another.

19. The method of claim 13, further including interlacing the yarns with one another in a braiding process.

20. The method of claim 19, further including braiding the wall being circumferentially continuous.
